(19) United States
(12) Patent Application Publication
(10) Pub. No.: US 2024/0266105 A1
(43) Pub. Date: Aug. 8, 2024

(54) TRANSFORMER ASSEMBLY INCLUDING COPPER STAMPINGS AS SECONDARY WINDINGS

(71) Applicant: Murata Manufacturing Co., Ltd., Nagaokakyo-shi (JP)

(72) Inventor: Zibran Aziz KHAN, Westborough, MA (US)

(21) Appl. No.: 18/422,394

(22) Filed: Jan. 25, 2024

Related U.S. Application Data
(60) Provisional application No. 63/443,761, filed on Feb. 7, 2023.

(51) Int. Cl. H01F 27/28; H01F 27/06; H01F 27/29; H01F 41/04

(52) U.S. Cl. CPC H01F 27/2847; H01F 27/06; H01F 27/29; H01F 2027/065; H01F 41/04

(57) ABSTRACT

A transformer assembly includes a core, a primary winding, and a secondary winding with a first coil and a second coil. Each of the first coil and the second coil is defined by a single stamping that includes two turns connected by a bend in the corresponding stamping and first and second terminals that are at opposite ends of the corresponding coil. Each of the first and second terminals extend in a terminal-extending direction that is perpendicular or substantially perpendicular to a plane defined by one of the two turns. The first terminal of the first coil and the first terminal of the second coil extend in the terminal-extending direction adjacent to each other to define a first junction point, and the second terminal of the first coil and the second terminal of the second coil extend in the terminal-extending direction adjacent to each other to define a second junction point.

### CROSS REFERENCE TO RELATED APPLICATIONS

This application claims the benefit of U.S. patent Application No. 63/443,761 filed on Feb. 7, 2023. The entire contents of this application are hereby incorporated by reference.

### BACKGROUND OF THE INVENTION

### 1. Field of the Invention

The present invention relates to transformers. More specifically, the present invention relates to the transformers that include copper-stamped secondary windings.

### 2. Description of the Related Art

FIG. 1 shows a perspective view of a known transformer assembly 10, and FIG. 2 shows an exploded view of the transformer assembly 10.

As shown in FIGS. 1 and 2, the transformer assembly 10 includes a bottom core 11 that mates with a top core 12. The bottom core 11 and the top core 12 can be attached by an adhesive 18. The transformer assembly 10 further includes a winding board 13, copper stampings 15, and a spacer 17. Power pins 14 can be inserted in, or attached to, the winding board 13. Polyimide tape 16 can be affixed to each of the copper stampings 15 to electrically isolate the copper stampings 15 from one another. Each of the copper stampings 15 defines only a single turn of the transformer assembly 10.

FIG. 3 shows a perspective view of three of the transformer assemblies 10 mounted to a main substrate 20 and a secondary substrate 30. Each of the main substrate 20 and the secondary substrate 30 can be a printed circuit board (PCB). FIG. 4 is a side view of the transformer assembly 10, the main substrate 20, and the secondary substrate 30 mounted to a heatsink/chassis 40. FIG. 5 is an assembly view of electrical connections between the copper stampings 15 of the transformer assembly 10 and the secondary substrate 30. FIG. 6 is a schematic view of the electrical connections between copper stampings 15 and the secondary substrate 30. The secondary windings include copper stamps 1, 2 connected in series with each other and include copper stamps 3, 4 connected in series with each other. Copper stamps 1, 2 are connected in parallel with copper stamps 3, 4. Terminal A is connected to copper stamps 1, 3; terminal B is connected to copper stamps 2, 4; terminal C is connected to a node between copper stamps 1, 2; and terminal D is connected to a node between copper stamps 3, 4.

In general, applications such as automotive power supply design can require two or more planar transformers, such as the three transformer assemblies 10 as shown in FIG. 3. However, each of the transformer assemblies 10 requires fourteen separate components, excluding the epoxy adhesive 18. Thus, the entire group of three of the transformer assemblies 10 shown in FIG. 3 requires 43 separate components, including the secondary substrate 30. Due to this high number of components, a relatively long and multi-step assembly process is required for the transformer assemblies 10. In particular, the multi-step assembly process requires the steps of mounting the transformer assemblies 10 to both the secondary substrate 30 and the main substrate 20.

Furthermore, each of the transformer assemblies 10 is connected to the secondary substrate 30 by six separate solder joints, and each of the transformer assemblies 10 includes two power pins 14 that are individually connected to the main substrate 20 by a solder joint. The secondary substrate 30 is also connected to the main substrate 20 by six separate solder joints. Thus, the three transformer assemblies 10 shown in FIG. 3 require 30 separate solder joints. Due to this high number of solder joints, which are included in at least two different planes, alignment issues between components can easily arise during assembly.

FIGS. 7 and 8 are exploded views of known copper stamping assemblies. As shown in FIGS. 7 and 8, copper stamping assemblies have conventionally included separate copper stampings, particularly copper stampings used as secondary windings. Accordingly, similar to the transformer assembly 10 described above, the copper stamping assemblies shown in FIGS. 7 and 8 require a high number of components, and thus may also require relatively long and multi-step assembly processes and/or a higher number of solder joints.

FIG. 8 further shows that a planar transformer further requires shield windings between the copper stampings (i.e., primary winding and secondary winding shown in FIG. 8). More specifically, FIG. 8 shows that shielding layers defined by the shield windings AB and CD are provided on either side of the primary winding, and shielding layers defined by shield windings DF and GH are provided on either side of the secondary winding. The shielding layers shown in FIG. 8 provide actively driven shields to provide electromagnetic shielding but require a six layer structure for only two single turn windings. Accordingly, the planar transformer shown in FIG. 8 requires a high number of components for a primary side that includes only one turn and a secondary side that includes only one turn.

### SUMMARY OF THE INVENTION

To overcome the problems described above, example embodiments of the present invention provide transformer assemblies including copper stampings that require a reduced number of parts, while also providing transformer assemblies that include two or more turns at a primary side, a secondary side, or both the primary side and the secondary side. Furthermore, the transformer assemblies according to the example embodiments of the present invention are able to be provided by a simple assembly process and with a lower number of solder joints, in particular, by providing secondary sides of the transformer assemblies with junction points (e.g., leads or pins) that are staked or soldered to a common mating hole. Accordingly, the transformer assemblies according to the example embodiments of the present invention are able to significantly reduce or prevent alignment issues during manufacturing and assembly.

A stamping according to an example embodiment of the present invention includes a first loop that is configured to define a first turn of a transformer assembly and a second loop that is configured to define a second turn of the transformer assembly. The stamping is stamped from a single, continuous sheet of metal.

The first loop and the second loop can be concentric or substantially concentric. A portion of the stamping that connects the first loop and the second loop can be bent. The first loop can be continuous with a first junction point of the stamping, and the second loop can be continuous with a second junction point of the stamping.

A transformer assembly according to an example embodiment of the present invention can include the stamping of any of the various other example embodiments of the present invention.

The transformer can further include a second stamping with a third loop that defines a third turn of a transformer assembly and a fourth loop that defines a fourth turn of the transformer assembly, and the second stamping can be stamped from a single, continuous sheet of metal. The first loop can be continuous with a first junction point of the transformer assembly, the second loop can be continuous with a second junction point of the transformer assembly, the third loop can be continuous with a third junction point of the transformer assembly, and the fourth loop can be continuous with a fourth junction point of the transformer assembly. The first junction point and the third junction point can be configured to be staked or soldered to a first hole of a mating substrate, and the second junction point and the fourth junction point can be configured to be staked or soldered to a second hole of the mating substrate.

The transformer can further include a third stamping with a fifth loop that defines a fifth turn of the transformer assembly and a sixth loop that defines a sixth turn of the transformer assembly, and the third stamping can be stamped from a single, continuous sheet of metal. The fifth loop can be continuous with a fifth junction point of the transformer assembly, and the sixth loop can be continuous with a sixth junction point of the transformer assembly. The first junction point, the third junction point, and the fifth junction point can be configured to be staked or soldered to a first hole of a mating substrate, and the second junction point, the fourth junction point, and the sixth junction point can be configured to be staked or soldered to a second hole of the mating substrate.

The transformer can further include a fourth stamping with a seventh loop that defines a seventh turn of the transformer assembly and an eighth loop that defines an eighth turn of the transformer assembly, and the fourth stamping can be stamped from a single, continuous sheet of metal. The seventh loop can be continuous with a seventh junction point of the transformer assembly, and the eighth loop can be continuous with an eighth junction point of the transformer assembly. The first junction point, the third junction point, the fifth junction point, and the seventh junction point can be configured to be staked or soldered to a first hole of a mating substrate, and the second junction point, the fourth junction point, the sixth junction point, and the eighth junction point can be configured to be staked or soldered to a second hole of the mating substrate.

At least the first loop and the second loop can define a secondary side of the transformer assembly. The first loop and the second loop can define a first secondary coil of the transformer assembly, and the third loop and the fourth loop can define a second secondary coil of the transformer assembly. The first secondary coil and the second secondary coil can be in parallel. The first secondary coil and the second secondary coil can be separated by a winding board.

The transformer assembly can include a primary coil with at least four turns, at least six turns, or at least eight turns.

The first junction point of the stamping can be bent with respect to a major planar surface of the first loop, and the second junction point of the stamping can be bent with respect to a major planar surface of the second loop.

A transformer assembly according to an example embodiment of the present invention includes a core, a primary winding, and a secondary winding with a first coil and a second coil. Each of the first coil and the second coil is defined by a single stamping that includes two turns connected by a bend in the corresponding stamping and first and second terminals that are at opposite ends of the corresponding coil. Each of the first and second terminals extend in a terminal-extending direction that is perpendicular or substantially perpendicular to a plane defined by one of the two turns. The first terminal of the first coil and the first terminal of the second coil extend in the terminal-extending direction adjacent to each other to define a first junction point, and the second terminal of the first coil and the second terminal of the second coil extend in the terminal-extending direction adjacent to each other to define a second junction point.

The transformer assembly can further include a third coil defined by a third single stamping that includes two turns connected by a bend in the third single stamping and first and second terminals that are at opposite ends of the third coil and that extend in the terminal-extending direction. The first terminal of the third coil can extend in the terminal-extending direction adjacent to the first terminal of the first coil and the first terminal of the second coil to define the first junction point, and the second terminal of the third coil can extend in the terminal-extending direction adjacent to the second terminal of the first coil and the second terminal of the second coil to define the second junction point.

The transformer assembly can further include a fourth coil defined by a fourth single stamping that includes two turns connected by a bend in the fourth single stamping and first and second terminals that are at opposite ends of the fourth coil and that extend in the terminal-extending direction. The first terminal of the fourth coil can extend in the terminal-extending direction adjacent to the first terminal of the first coil, the first terminal of the second coil, and the first terminal of the third coil to define the first junction point, and the second terminal of the fourth coil can extend in the terminal-extending direction adjacent to the second terminal of the first coil, the second terminal of the second coil, and the second terminal of the third coil to define the second junction point.

The transformer assembly can further include a winding board between the first and the second coils, and the primary winding can include traces on and/or in the winding board. The transformer assembly can further include power pins connected to the winding board.

The core can include a top core and a bottom core. The top core and the bottom core can be arranged in an EI arrangement.

The first and the second stampings can include copper. The transformer assembly can further include a spacer between the core and the second coil. The transformer assembly can further include a polyimide tape between the two turns of each of the first and the second coils.

A power supply according to an example embodiment of the present invention can include the transformer assembly according to various other example embodiments of the present invention and a substrate with first and second through holes. The first terminal of the first coil and the first terminal of the second coil can extend into the first through hole, and the second terminal of the first coil and the second terminal of the second coil can extend into the second through hole.

A power supply according to an example embodiment of the present invention can include the transformer assembly according to various other example embodiments of the present invention and a substrate with first and second through holes. The first terminal of the first coil, the first terminal of the second coil, and the first terminal of the third coil can extend into the first through hole, and the second terminal of the first coil, the second terminal of the second coil, and the second terminal of the third coil can extend into the second through hole.

A power supply according to an example embodiment of the present invention can include the transformer assembly according to various other example embodiments of the present invention and a substrate with first and second through holes. The first terminal of the first coil, the first terminal of the second coil, the first terminal of the third coil, and the first terminal of the fourth coil can extend into the first through hole, and the second terminal of the first coil, the second terminal of the second coil, the second terminal of the third coil, and the second terminal of the fourth coil can extend into the second through hole.

The substrate of the power supply can include an opening, and the transformer assembly can be located within the opening. The power supply can further include two additional transformer assemblies located within the opening. The transformer module can be directly connected to the substrate without using another substrate.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a perspective view of a known transformer assembly.

FIG. 2 shows an exploded view of the known transformer assembly of FIG. 1.

FIG. 3 shows a perspective view of three of the known transformer assemblies of FIG. 1 mounted to a main substrate and a secondary substrate.

FIG. 4 is a side view of the known transformer assembly, main substrate, and secondary substrate of FIG. 3 mounted to a heatsink or chassis.

FIG. 5 is an assembly view of electrical connections between copper stampings of the known transformer assembly of FIG. 1 and the secondary substrate of FIG. 3.

FIG. 6 is a schematic view of electrical connections between copper stampings of the known transformer assembly of FIG. 1 and the secondary substrate of FIG. 3.

FIGS. 7 and 8 are exploded views of known copper stamping assemblies.

FIG. 9 shows a perspective view of a transformer assembly according to an example embodiment of the present invention.

FIG. 10 shows an exploded view of the transformer assembly of FIG. 9.

FIG. 11 shows a cross-sectional view of the transformer assembly of FIG. 9.

FIG. 12 shows a perspective view of a three of the transformer assemblies of FIG. 9 mounted to a main substrate.

FIG. 13 shows a perspective view of a copper stamping of the transformer assembly of FIG. 9 after an initial stamping process.

FIGS. 14 to 17 show perspective, top, front, and side views of the copper stamping of FIG. 13 after a bending process.

FIGS. 18 to 23 show an implementation of a four-turn configuration of a transformer assembly according to an example embodiment of the present invention.

FIGS. 24 to 29 show an implementation of a six-turn configuration of a transformer assembly according to an example embodiment of the present invention.

FIGS. 30 to 35 show an implementation of an eight-turn configuration of a transformer assembly according to an example embodiment of the present invention.

### DETAILED DESCRIPTION OF EXAMPLE EMBODIMENTS

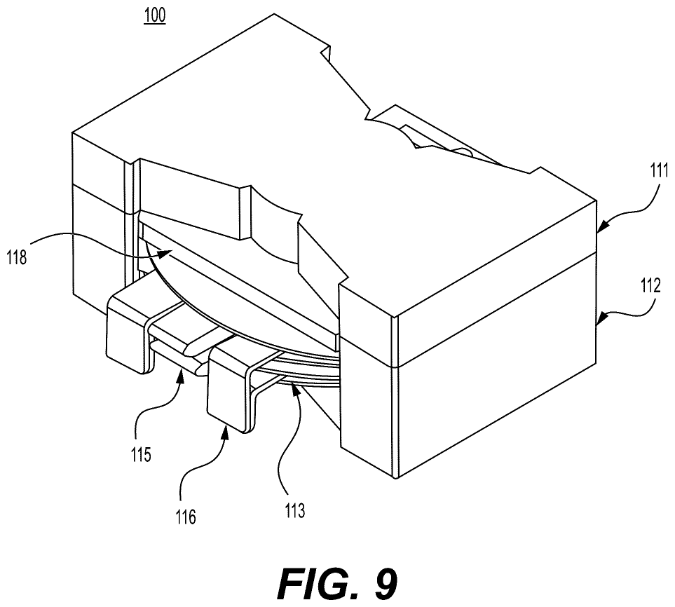

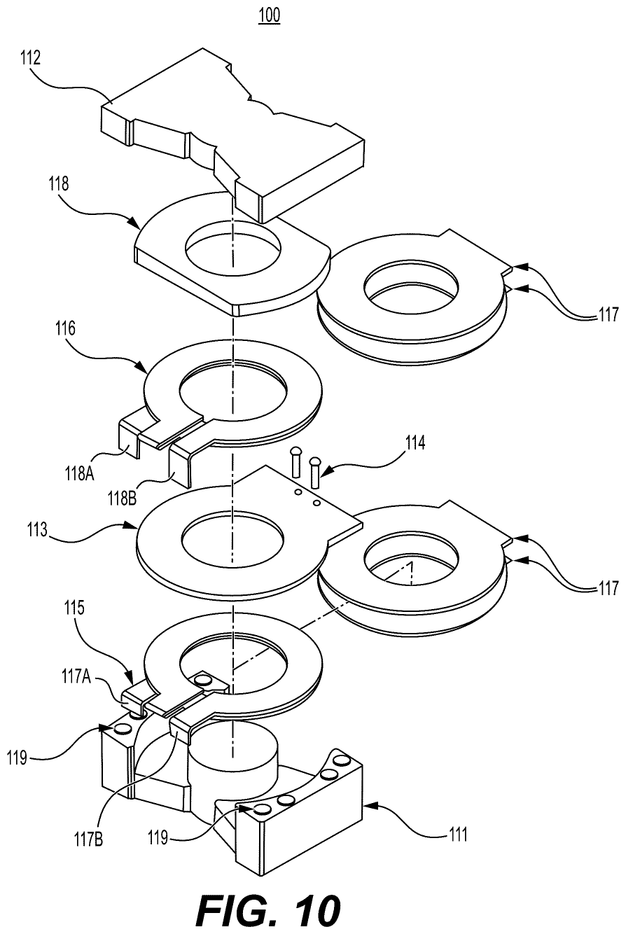

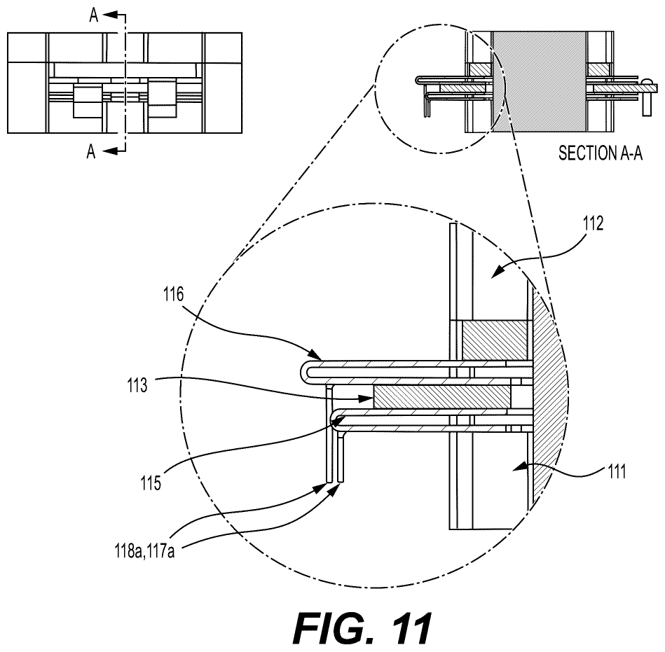

FIG. 9 shows a perspective view of a transformer assembly 100 according to an example embodiment of the present invention. FIG. 10 shows an exploded view of the transformer assembly 100, and FIG. 11 shows a cross-sectional view of the transformer assembly 100.

As shown in FIGS. 9 to 11, the transformer assembly 100 can include a bottom core 111 that mates with a top core 112. The bottom core 111 and the top core 112 can both be ferrite cores. As shown in FIG. 10, the bottom core 111 can be an “E” core, and the top core 112 can be an “I” core. Other core arrangements other than the EI arrangement shown in FIGS. 9 to 11 are also possible. For example, the top core 112 can be an “E” core, and the bottom core 111 can be an “E” or I“” core. The bottom core 111 and the top core 112 can be attached by an epoxy adhesive 119 or the like. The transformer assembly 100 further includes a winding board 113, a first copper stamping 115, a second copper stamping 116, and a spacer 118. The winding board 113 can be any suitable substrate, including, for example, a printed circuit board (PCB). The first copper stamping 115 and the second copper stamping 116 can be, for example, 0.4-mm thick copper stamping, but other thicknesses are possible. The first and second copper stampings 115, 116 can include other conductive materials instead of copper. The spacer 118 can be any suitable insulator, and in some applications, the spacer 118 can be omitted. Power pins 114 or the like can be inserted in, or attached to, the winding board 113. The power pins 114 can provide a physical connection and an electrical connection between the winding board 113 and the main substrate 120 (not shown in FIGS. 9 to 11). Polyimide tape 117 or the like can be affixed to each of the first copper stamping 115 and the second copper stamping 116. Each of the first copper stamping 115 and the second copper stamping 116 can define two or more turns of the transformer assembly 100.

The first copper stamping 115 can define a first coil that includes terminals 117a, 117b at opposite ends of the first coil, and the second copper stampings 116 can define a second coil that includes terminals 118a, 118b at opposite ends of the second coil. The terminals 117a, 117b, 118a, 118b can be bent downward. If the turns of the transformer define a plane, then the terminals 117a, 117b, 118a, 118b can extend in a terminal-extending direction that is perpendicular or substantially perpendicular, within manufacturing and/or measurement tolerances, to the plane defined by the turns of the transformer. A primary winding can include traces on and/or in the winding board 113 that can define any number of turns, and a secondary winding can include the first copper stamping 115 and the second copper stamping 116. For example, power can be applied to the primary windings from the main substrate 120 through the power pins 114, and power can be received at the terminals 117a, 117b, 118a, 118b. It is also possible to reverse the direction of power flow so that power can be applied to the secondary windings and can be received by the primary windings.

The upper left portion of FIG. 11 shows a front view of the transformer assembly 100. The upper right portion of FIG. 11 shows a sectional view of the transformer assembly 100 along line A-A in the upper left portion of FIG. 11. The bottom portion of FIG. 11 shows a close-up of a portion of the sectional view shown in the upper right portion of FIG. 11. The second copper stamping 116 is stacked on top of the first copper stamping 115 with the wiring board 113 between the first copper stamping 115 and the second copper stamping 116. The terminals 117a, 117b (only terminal 117a is shown in FIG. 11) of the first copper stamping 115 and the terminals 118a, 118b (only terminal 118a is shown in FIG. 11) of the second copper stampings 116 can be bent downward such that the terminals 117a, 118a and 117b, 118b extend downward adjacent to each other. The terminals 117a, 118a can be connected to define a first junction point, and the terminals 117b, 118b can be connected to define a second junction point.

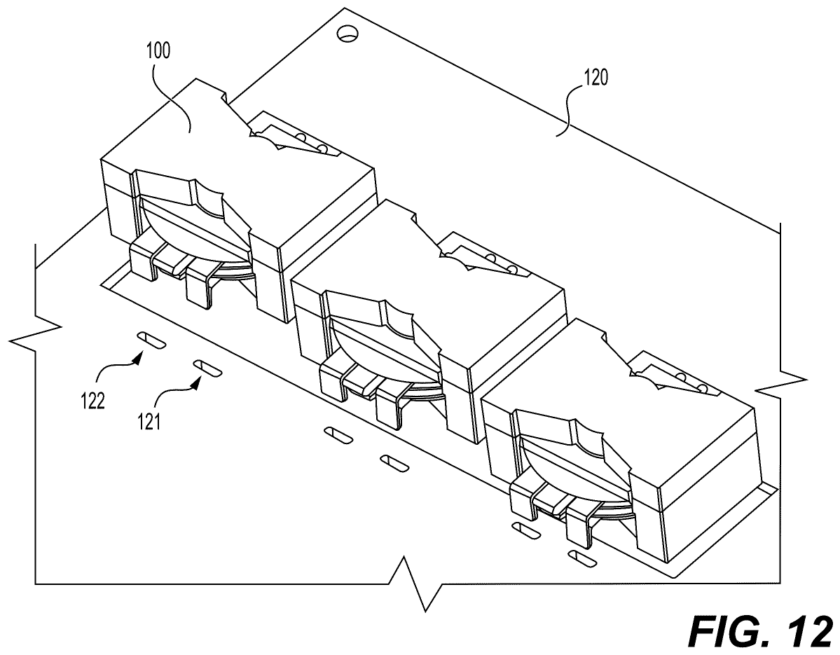

FIG. 12 shows a perspective view of three of the transformer assemblies 100 mounted to a main substrate 120. The main substrate 120 can include one or more openings through which a portion of the transformer assemblies 100 extend. The main substrate 120 can be, for example, a PCB. The main substrate 120 can include through holes 121, 122 into which the terminals 117a, 117b, 118a, 118b can extend to connect the secondary winding to the main substrate 120. Although not shown in FIG. 12, the main substrate 120 can include additional through holes into which the power pins 114 can extend to connect the primary winding to the main substrate 120. The terminals 117a, 118a can both be inserted into the through hole 122, and the terminals 117b, 118b can be inserted into the through hole 121. The terminals 117a, 117b, 118a, 118b can be soldered to form an electrical and a physical connection. Alternatively, in some applications, instead of using through holes 121, 122, the terminals 117a, 117b, 118a, 118b could be surface-mount technology (SMT) terminals that can be surface mounted to the main substrate 120. Similarly, in some applications, the power pins 114 could be SMT terminals that can be surface mounted to the main substrate 120. The three transformer assemblies 100 and the main substrate 120 can be included in a power supply, such as an automotive power supply. A secondary substrate is not required to provide electrical connections between the first copper stampings 115 or the second copper stampings 116.

As shown in FIG. 11, terminals 117a, 117b, 118a, 118b can be used to electrically connect the first copper stamping 115 and the second copper stamping 116 to the main substrate 120. Accordingly, each of the first copper stamping 115 and the second copper stamping 116 can be directly connected to the main substrate 120 without the use of a secondary substrate. That is, additional junction points provided by a secondary substrate or the like are not required.

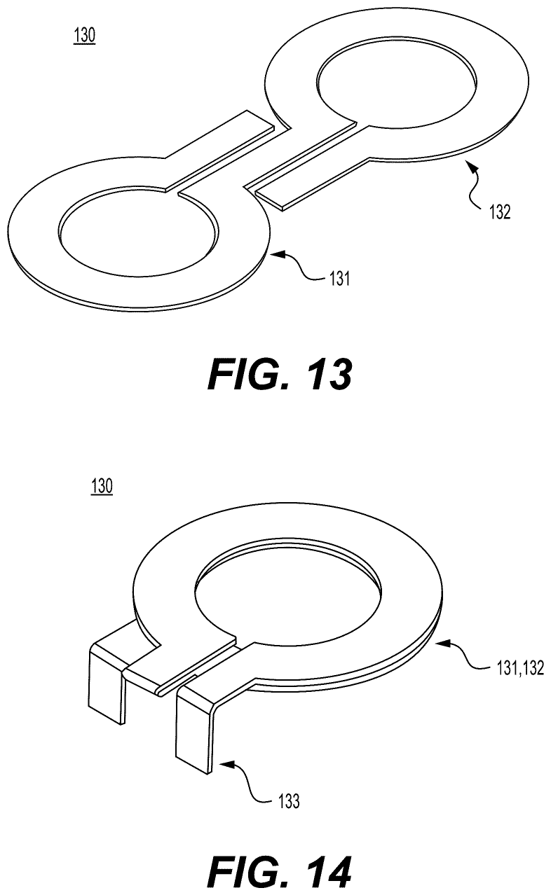

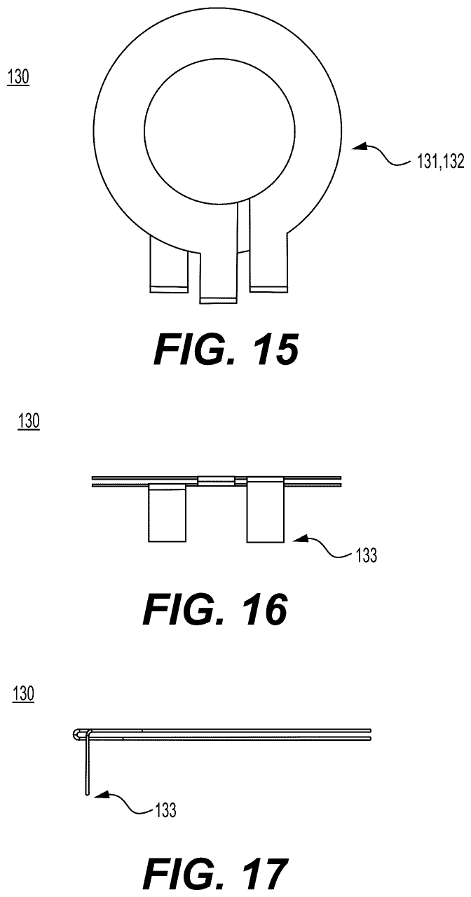

FIGS. 13 to 17 show an example of a copper stamping 130, which can define either or both of the first copper stamping 115 or the second copper stamping 116. The first copper stamping 115 and the second copper stamping can each include the same or similarly shaped turns. As shown in FIGS. 13 to 17, the turns can have a circular, square, or other suitable shape. The terminals 118a, 118b of the second copper stamping 116 can extend farther from the turns of the second copper stamping 116 than how far the terminals 117a, 117b extend from the turns of the first copper stamping 115. With this arrangement of the terminals 117a, 118a and the terminals 117b, 118b, the second copper stamping 116 can be nested with the first copper stamping 115 with the terminals 117a, 118a and the terminals 117b, 118b extending downward adjacent to each other so that the terminals 117a, 118a and the terminals 117b, 118b can define first and second junction points, respectively, and can be inserted into the same through hole 122, 121, respectively, in the main substrate 120.

FIG. 13 shows a perspective view of the copper stamping 130 after an initial stamping process. As shown in FIG. 13, the copper stamping 130 can be initially defined by a flat pattern stamped from a flat sheet of copper. The copper stamping initially includes two or more turns 131 and 132 that are coplanar. After the initial stamping process, the copper stamping 130 undergoes a bending process to provide the copper stamping 130 with a shape that can be included in the transformer assembly 100. A bend connects the turns 131 and 132 together, replacing a junction point compared to the transformer assembly 10. FIGS. 14 to 17 respectively show a perspective, top, front, and side views of the copper stamping 130 after the bending process. As shown in FIG. 14, terminals 133 of the copper stamping 130 can be bent away from a major planar surface of each of the two or more turns 131 and 132. After the bending process, the two or more turns 131 and 132 are concentric or substantially concentric and define a coil.

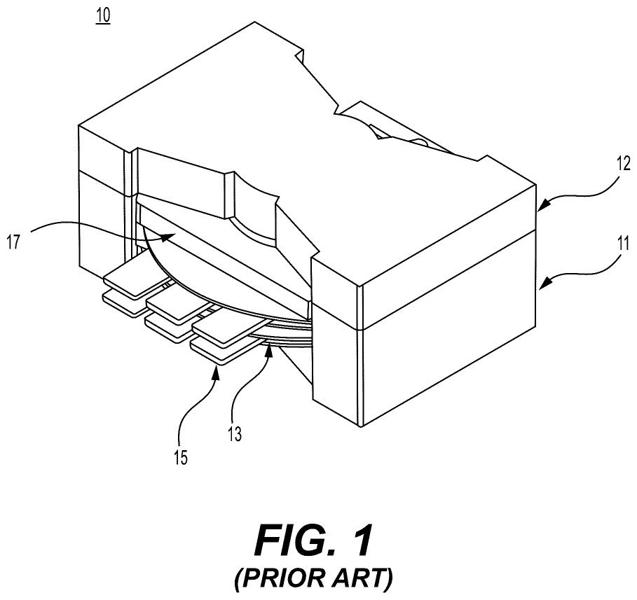

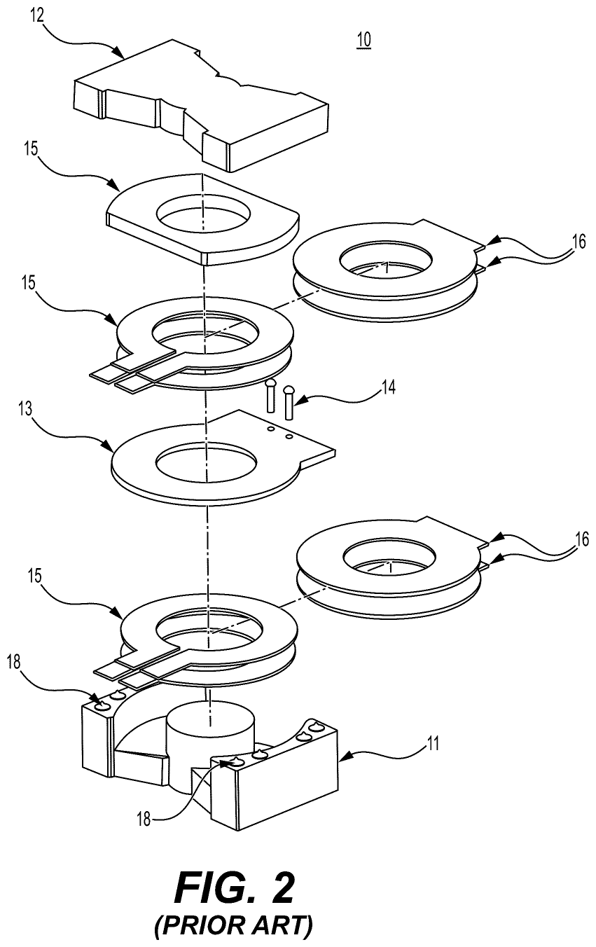

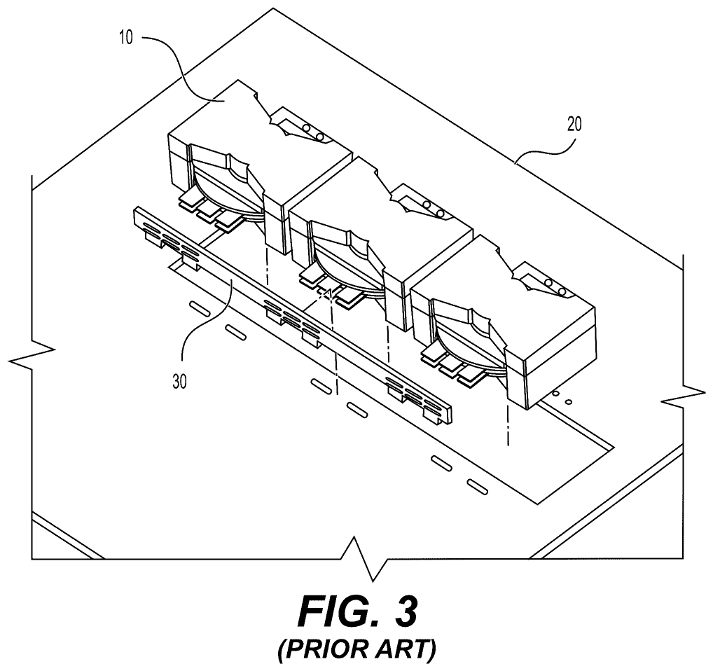

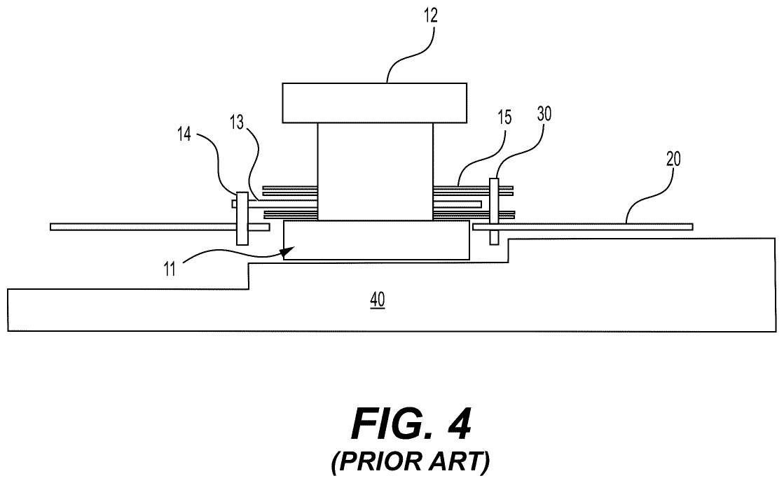

By providing the copper stamping 130 in the shape shown in FIGS. 14 to 17, a single one of the copper stampings 130 can replace two or more of the copper stampings 15 shown in FIGS. 1 to 5. A single copper stamping 130 can define two or more turns 131 and 132, whereas the copper stamping 15 defines only a single turn. Thus, by providing the copper stamping 130 with a single, continuous, monolithic shape that defines two or more turns, an overall number of components and an overall number of solder joints included in the transformer assembly 100 can be reduced when compared to the copper stampings 15 of the transformer assembly 10.

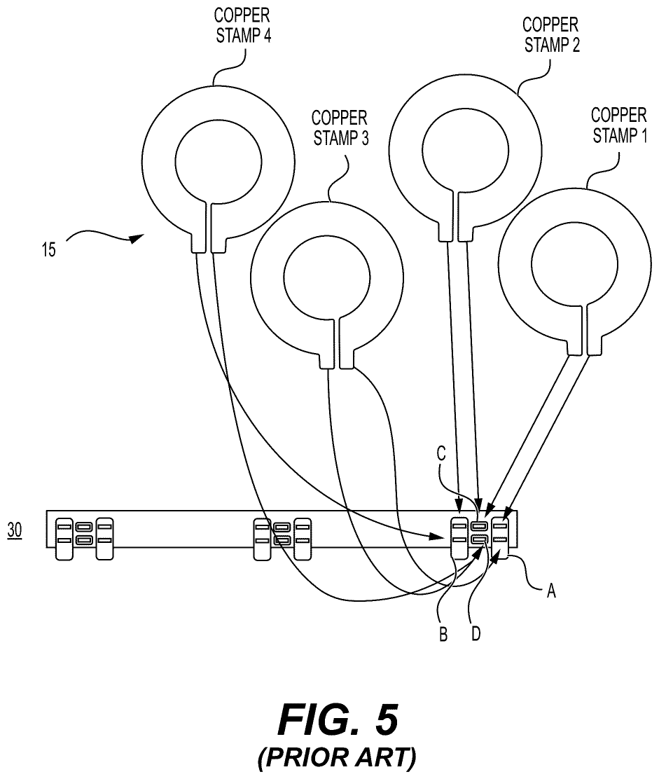

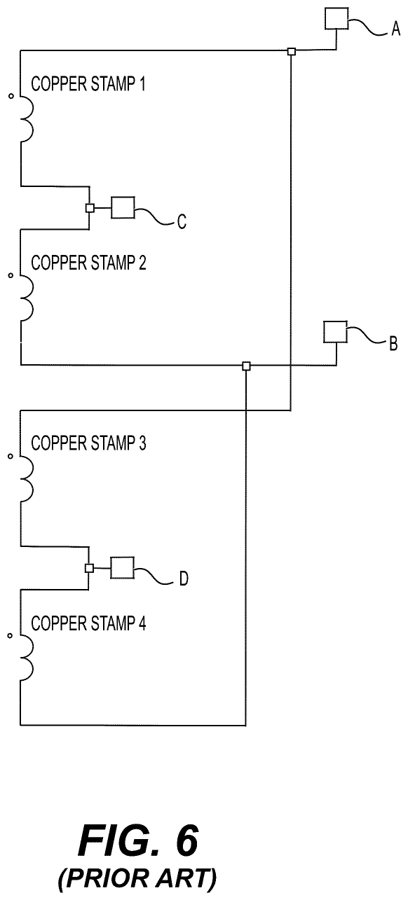

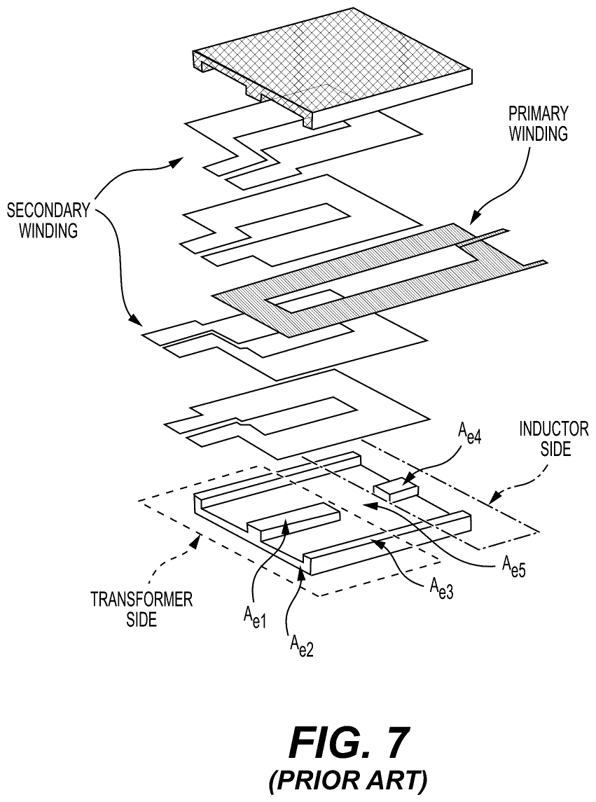

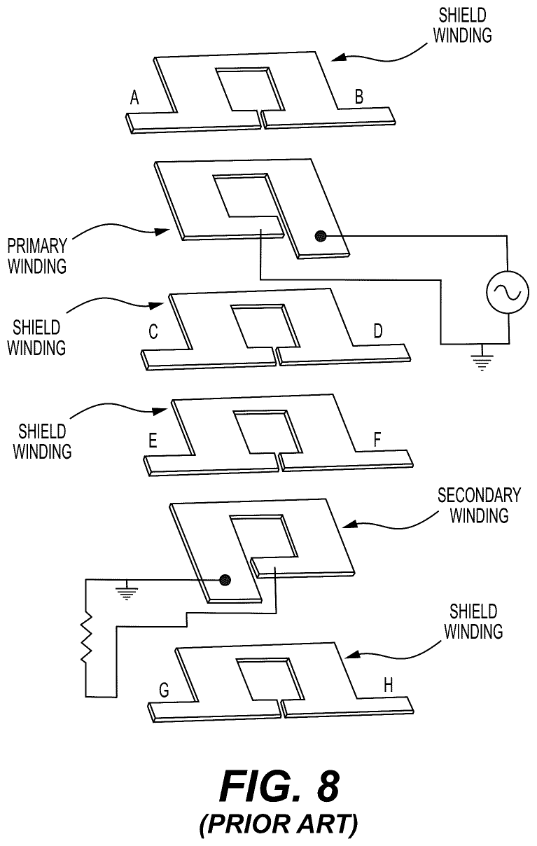

In addition, the transformer assembly 100 does not require a secondary substrate or the like, as the electrical connections provided by the secondary substrate 30 (as shown in FIGS. 5 and 6) are not necessary to connect the turns defined by the single copper stamping 130. In contrast to the transformer assembly 10, which requires four separate junction points A to D (as shown in FIG. 5), the transformer assembly 100 only includes two junction points, i.e., first and second junctions points, defined by terminals 117a, 117b, 118a, 118b (as shown in FIGS. 10 and 11) that directly electrically connect each of the first copper stamping 115 and the second copper stamping 116 to the main substrate 120. The terminals 117a, 117b, 118a, 118b can correspond to the terminals 133 shown in FIGS. 14, 16, and 17.

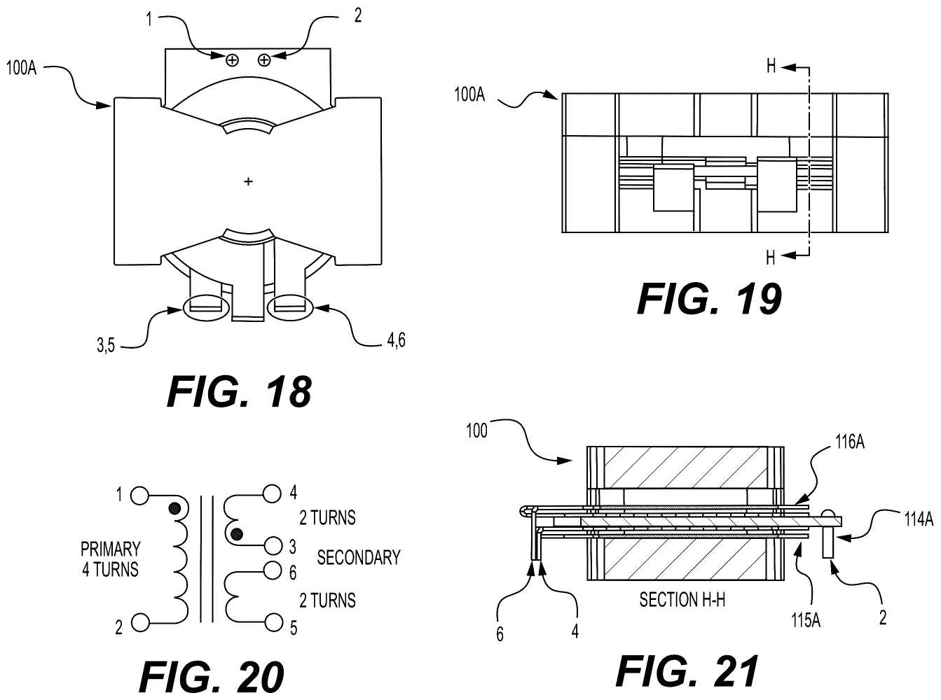

FIGS. 18 to 23 show an implementation of a four-turn configuration of a transformer assembly 100A according to an example embodiment of the present invention.

The structure of the transformer assembly 100A is similar to the transformer assembly 100 described above, and can be mounted to the main substrate 120. The transformer assembly 100A includes a first copper stamping 115A and a second copper stamping 116A.

As shown in FIGS. 18, 20, 21, and 23, the first copper stamping 115A includes nodes 3 and 4, and the second copper stamping 116A includes nodes 5 and 6. The nodes 4 and 6 can be connected to define a first junction point, and the nodes 3 and 5 can be connected to define a second junction point. The nodes 3 and 4 define connection points or terminals of a first two-turn secondary coil of the transformer assembly 100A, and the nodes 5 and 6 define connection points or terminals of a second two-turn secondary coil of the transformer assembly 100A. A four-turn primary coil of the transformer assembly 100A can be connected to nodes 1 and 2, and the nodes 1 and 2 can be defined by power pins 114A.

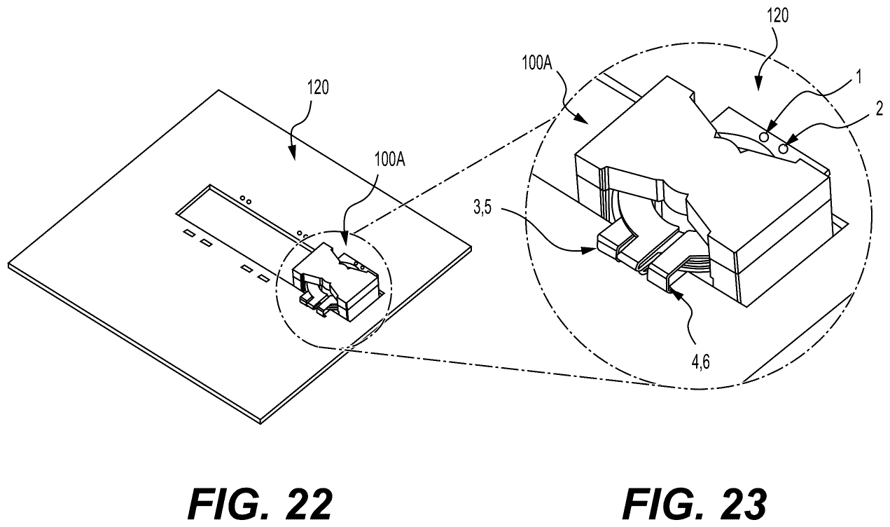

Accordingly, the transformer assembly 100A is able to provide a primary side that includes four turns and a secondary side that includes two two-turn coils connected in parallel. Furthermore, as shown in FIGS. 22 and 23, node 3 of the first copper stamping 115A and node 5 of the second copper stamping 116A can be staked or soldered to the same hole, or mounted in a directly adjacent position, on the main substrate 120. Similarly, node 4 of the first copper stamping 115A and node 6 of the second copper stamping 116A can be staked or soldered to the same hole, or mounted in a directly adjacent position, on the main substrate 120. Thus, for example, nodes 3 and 5 can be soldered together, and nodes 4 and 6 can be soldered together.

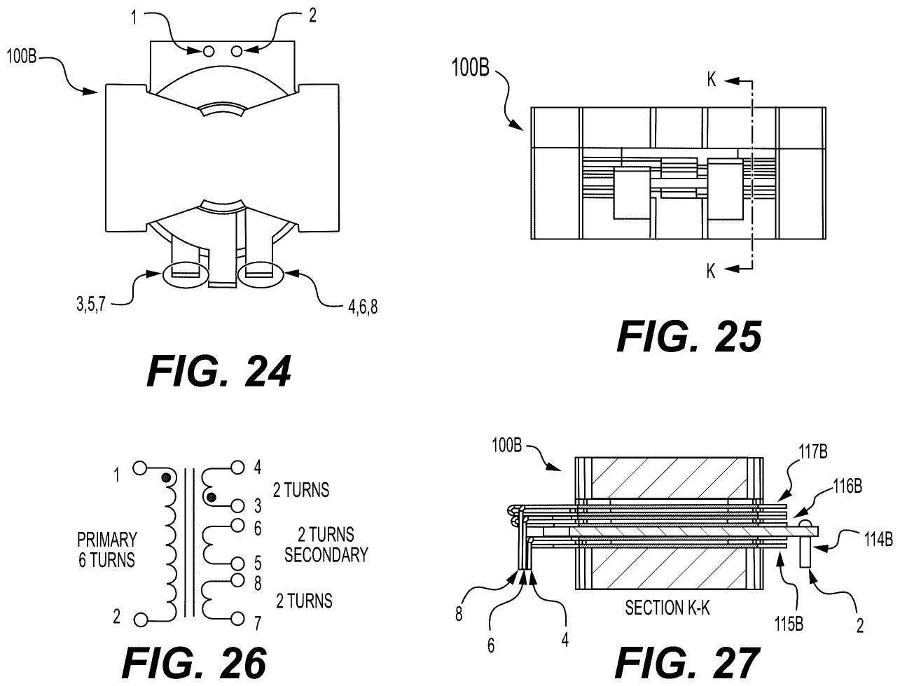

FIGS. 24 to 29 show an implementation of a six-turn configuration of a transformer assembly 100B according to an example embodiment of the present invention.

The structure of the transformer assembly 100B is similar to the transformer assembly 100 described above, and can be mounted to the main substrate 120. However, the transformer assembly 100B includes a first copper stamping 115B, a second copper stamping 116B, and a third copper stamping 117B.

As shown in FIGS. 24, 26, 27, and 29, the first copper stamping 115B includes nodes 3 and 4, the second copper stamping 116B includes nodes 5 and 6, and the third copper stamping 117B includes nodes 7 and 8. The nodes 4, 6, and 8 can be connected to define a first junction point, and the nodes 3, 5, and 7 can be connected to define a second junction point. The nodes 3 and 4 define connection points or terminals of a first two-turn secondary coil of the transformer assembly 100B, the nodes 5 and 6 define connection points or terminals of a second two-turn secondary coil of the transformer assembly 100B, and the nodes 7 and 8 define connection points or terminals of a third two-turn secondary coil of the transformer assembly 100B. A six-turn primary coil of the transformer assembly 100B can be connected to nodes 1 and 2, and the nodes 1 and 2 can be defined by power pins 114B.

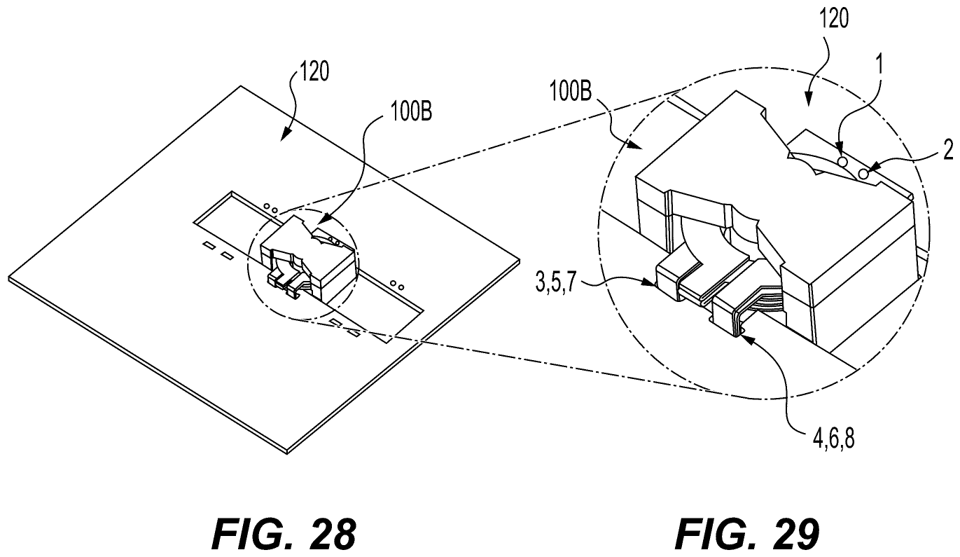

Accordingly, the transformer assembly 100B is able to provide a primary side that includes six turns and a secondary side that includes three two-turn coils connected in parallel. Furthermore, as shown in FIGS. 28 and 29, node 3 of the first copper stamping 115B, node 5 of the second copper stamping 116B, and node 7 of the third copper stamping 117B can be staked or soldered to the same hole, or mounted in a directly adjacent position, on the main substrate 120. Similarly, node 4 of the first copper stamping 115B, node 6 of the second copper stamping 116B, and node 8 of the third copper stamping 117B can be staked or soldered to the same hole, or mounted in a directly adjacent position, on the main substrate 120. Thus, for example, nodes 3, 5, and 7 can be soldered together, and nodes 4, 6, and 8 can be soldered together.

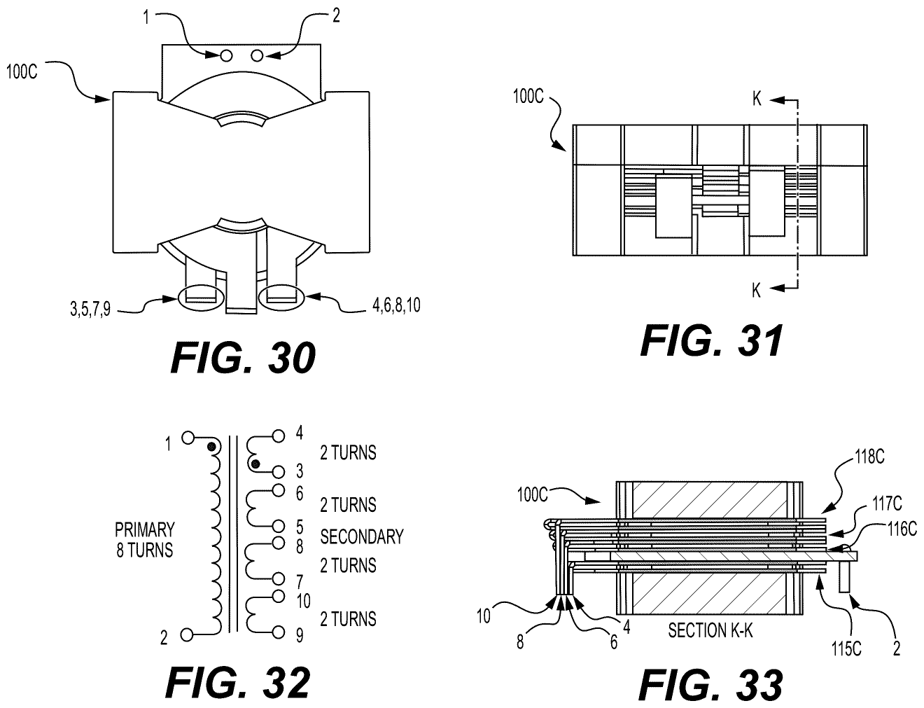

FIGS. 30 to 35 show an implementation of an eight-turn configuration of a transformer assembly 100C according to an example embodiment of the present invention.

The structure of the transformer assembly 100C is similar to the transformer assembly 100 described above, and can be mounted to the main substrate 120. However, the transformer assembly 100C includes a first copper stamping 115C, a second copper stamping 116C, a third copper stamping 117C, and a fourth copper stamping 118C.

As shown in FIGS. 30, 32, 33, and 35, the first copper stamping 115C nodes 3 and 4, the second copper stamping 116C includes nodes 5 and 6, the third copper stamping 117C includes nodes 7 and 8, and the fourth copper stamping 118C includes nodes 9 and 10. The nodes 4, 6, 8, and 10 can be connected to define a first junction point, and the nodes 3, 5, 7, and 9 can be connected to define a second junction point. The nodes 3 and 4 define connection points or terminals of a first two-turn secondary coil of the transformer assembly 100C, the nodes 5 and 6 define connection points or terminals of a second two-turn secondary coil of the transformer assembly 100C, the nodes 7 and 8 define connection points or terminals of a third two-turn secondary coil of the transformer assembly 100C, and the nodes 9 and 10 define connection points or terminals of a fourth two-turn secondary coil of the transformer assembly 100C. An eight-turn primary coil of the transformer assembly 100C can be connected to nodes 1 and 2, and the nodes 1 and 2 can be defined by power pins 114C.

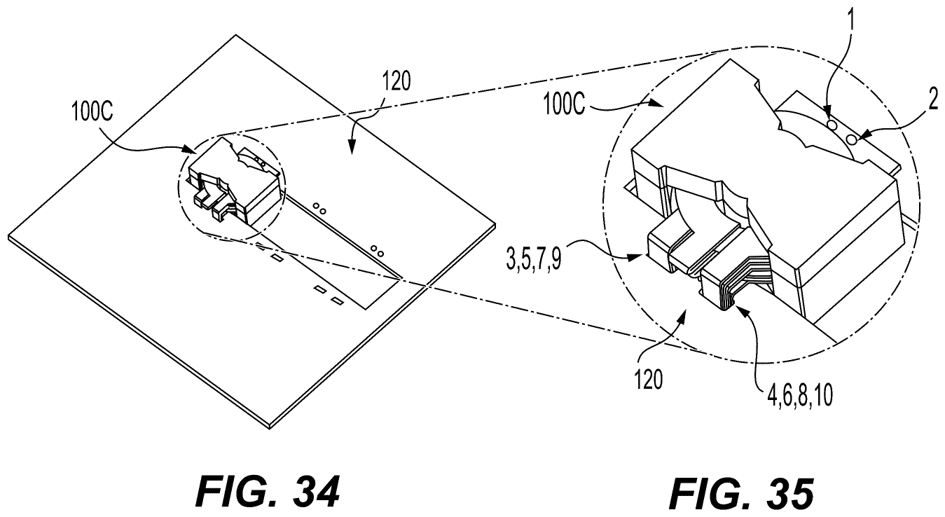

Accordingly, the transformer assembly 100C is able to provide a primary side that include eight turns and a secondary side that includes four two-turn coils connected in parallel. Furthermore, as shown in FIGS. 34 and 35, node 3 of the first copper stamping 115C, node 5 of the second copper stamping 116C, node 7 of the third copper stamping 117C, and node 9 of the fourth copper stamping 118C can be staked or soldered to the same hole, or mounted in a directly adjacent position, on the main substrate 120. Similarly, node 4 of the first copper stamping 115C, node 6 of the second copper stamping 116C, node 8 of the third copper stamping 117C, and node 10 of the fourth copper stamping 118C can be staked or soldered to the same hole, or mounted in a directly adjacent position, on the main substrate 120. Thus, for example, nodes 3, 5, 7, and 9 can be soldered together, and nodes 4, 6, 8, and 10 can be soldered together.

Further to the example embodiments described above, the present invention can be applied to transformers that include any number of turns and to transformers that included different combinations of primary and/or secondary turns. In addition, a power supply that includes two or more of the transformers according to the example embodiments of the present invention can include transformers with different configurations with respect to one another. The example embodiments of the present invention can be applied to various components that convert, supply, and/or store electrical power, including, but not limited to, DC-DC converters, AC-DC converters, bi-directional converters, power supplies, battery chargers, on-board chargers, battery equalizers, and the like. The example embodiments of the present invention can be applied to various applications, including, but not limited to, communication, industrial, medical, automotive, railway, robotics, battery management systems, and the like.

Although copper stampings have been described herein, the example embodiments of the present invention are not limited specifically to copper stampings. Copper may be replaced with any suitable conductive material or mixture of materials (e.g., gold plating). Furthermore, the example embodiments of the present invention are not limited specifically to stamping and bending processes, and conductive materials may be formed by other processes (e.g., casting). The copper stampings are also not limited to the specific shape shown in the drawings, and any suitable shape may be used. For example, the turns of the copper stampings are not limited to a circular shape, and can be implemented with other shapes (e.g., oval or rectangular shapes).

It is noted that the example embodiments of the present invention can be applied to any application that includes planar transformers that with copper stampings as secondary windings.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A transformer assembly comprising:
a core;
a primary winding;
a secondary winding including:
a first coil defined by a first single stamping that includes:
two turns connected by a bend in the first single stamping; and
first and second terminals that are at opposite ends of the first coil and that extend in a terminal-extending direction that is perpendicular or substantially perpendicular to a plane defined by one of the two turns;
a second coil defined by a second single stamping that includes:
two turns connected by a bend in the second single stamping; and
first and second terminals that are at opposite ends of the second coil and that extend in the terminal-extending direction; wherein
the first terminal of the first coil and the first terminal of the second coil extend in the terminal-extending direction adjacent to each other to define a first junction point; and
the second terminal of the first coil and the second terminal of the second coil extend in the terminal-extending direction adjacent to each other to define a second junction point.

2. The transformer assembly of claim 1, further comprising a third coil defined by a third single stamping that includes:
two turns connected by a bend in the third single stamping; and
first and second terminals that are at opposite ends of the third coil and that extend in the terminal-extending direction; wherein
the first terminal of the third coil extends in the terminal-extending direction adjacent to the first terminal of the first coil and the first terminal of the second coil to define the first junction point; and
the second terminal of the third coil extends in the terminal-extending direction adjacent to the second terminal of the first coil and the second terminal of the second coil to define the second junction point.

3. The transformer assembly of claim 2, further comprising a fourth coil defined by a fourth single stamping that includes:
two turns connected by a bend in the fourth single stamping; and
first and second terminals that are at opposite ends of the fourth coil and that extend in the terminal-extending direction; wherein
the first terminal of the fourth coil extends in the terminal-extending direction adjacent to the first terminal of the first coil, the first terminal of the second coil, and the first terminal of the third coil to define the first junction point; and
the second terminal of the fourth coil extends in the terminal-extending direction adjacent to the second terminal of the first coil, the second terminal of the second coil, and the second terminal of the third coil to define the second junction point.

4. The transformer assembly of claim 1, further comprising a winding board between the first and the second coils; wherein
the primary winding includes traces on and/or in the winding board.

5. The transformer assembly of claim 4, further comprising power pins connected to the winding board.

6. The transformer assembly of claim 1, wherein the first and the second stampings include copper.

7. The transformer assembly of claim 1, wherein the core includes a top core and a bottom core.

8. The transformer assembly of claim 7, wherein the top core and the bottom core are arranged in an EI arrangement.

9. The transformer assembly of claim 1, further comprising a spacer between the core and the second coil.

10. The transformer assembly of claim 1, further comprising a polyimide tape between the two turns of each of the first and the second coils.

11. A power supply comprising:
a substrate with first and second through holes; and
a transformer assembly of claim 1; wherein
the first terminal of the first coil and the first terminal of the second coil extend into the first through hole; and
the second terminal of the first coil and the second terminal of the second coil extend into the second through hole.

12. A power supply comprising:
a substrate with first and second through holes; and
a transformer assembly of claim 2; wherein
the first terminal of the first coil, the first terminal of the second coil, and the first terminal of the third coil extend into the first through hole; and
the second terminal of the first coil, the second terminal of the second coil, and the second terminal of the third coil extend into the second through hole.

13. A power supply comprising:
a substrate with first and second through holes; and
a transformer assembly of claim 3; wherein
the first terminal of the first coil, the first terminal of the second coil, the first terminal of the third coil, and the first terminal of the fourth coil extend into the first through hole; and
the second terminal of the first coil, the second terminal of the second coil, the second terminal of the third coil, and the second terminal of the fourth coil extend into the second through hole.

14. The power supply of claim 11, wherein
the substrate includes an opening; and
the transformer assembly is located within the opening.

15. The power supply of claim 11, further comprising two additional transformer assemblies located within the opening.

16. The power supply of claim 11, wherein the transformer module is directly connected to the substrate without using another substrate.
